(19) United States
(12) Patent Application Publication
(10) Pub. No.: US 2016/0172645 A1
(43) Pub. Date: Jun. 16, 2016

(54) MULTI-LAYERED POROUS FILM AND METHOD FOR PREPARING THE SAME

(71) Applicant: Industrial Technology Research Institute, Hsinchu County (TW)

(72) Inventors: Chih-Hung Lee, Hsinchu (TW); Dan-Cheng Kong, Hsinchu (TW)

(21) Appl. No.: 14/964,326

(22) Filed: Dec. 9, 2015

(30) Foreign Application Priority Data
Dec. 10, 2014 (TW) 103142969

(51) Int. Cl. H01M 2/16; H01M 2/14; B32B 27/32; B32B 3/26; B32B 27/08

(52) U.S. Cl. CPC H01M 2/1686; B32B 3/26; B32B 27/08; B32B 27/32; H01M 2/1653; H01M 2/145; B32B 2250/03; B32B 2250/242; B32B 2307/304; B32B 2457/10

(57) ABSTRACT

A multi-layered porous film is provided. The film includes a first porous layer having a first plurality of pores each with an aspect ratio of from 1:2 to 1:5; a second porous layer having a second plurality of pores each with an aspect ratio of from 1:2 to 1:5; and a thermal-resistance layer having a third plurality of pores, wherein the thermal-resistance layer is disposed between the first porous layer and the second porous layer, and has 50 wt % to 80 wt % of inorganic particles. A method for preparing the above multi-layered porous film is further provided.

### CROSS-REFERENCE TO RELATED APPLICATION

The present disclosure is based on, and claims priority from Taiwan Application Serial Number 103142969, filed on Dec. 10, 2014, the disclosure of which is hereby incorporated by reference herein in its entirety.

### TECHNICAL FIELD

The present disclosure relates to a multi-layered porous film and a method for preparing the same, especially to a multi-layered porous film with high thermal stability and formed by dry co-extrusion.

### BACKGROUND

Currently lithium batteries have been widely applied on portable electronic products. As electrical cars develop, the demand for the relevant materials becomes remarkable. Lithium batteries have the advantages of having high-energy density, such that the demand for power lithium batteries for cars is met. However, because of its large power output and the increasing battery size, the batteries produce a large amount of thermal energy while working. If no effective protective mechanism is used, the batteries are likely to endure thermal runaway, leading to explosion caused by battery combustion. In the lithium batteries, the separator films are important materials responsible for the safety and ion conduction for carrying out the chemical reactions. Hence, the separator films need to have good ion conductivity and sufficient mechanical strength, to prevent the short circuit caused by its fracture occurred during the fabrication or use. More importantly, when the temperatures of the lithium batteries are abnormally increased, the feature of thermal shutdown caused by fusion of heat of the separator films blocks ion conductivity, and thereby terminating the reaction to avoid continuous heat release. The temperature interval from thermal shutdown to film fracture of an insulating film is the effective working interval for the protective mechanism of the thermal shutdown. The effect of thermal shutdown becomes more obvious, as the interval gets larger. Accordingly, the current issues are how to effectively expand the temperature working interval for thermal shutdown and increase the safety of lithium batteries during use, in response to the future development of high power lithium batteries.

### SUMMARY

The present disclosure provides a multi-layered porous film and a method for preparing the same. The multi-layered porous film with even distribution of a pore diameter and larger curvature of pores, as made by dry co-extrusion, is suitable for use in lithium batteries with a larger electrical current output. The multi-layered porous film of the present disclosure has good permeability, even porosity, sufficient mechanical strength and excellent thermal tolerance, such that it can improve the performance and safety of a lithium battery when being used as a separator film in the battery.

According to an embodiment of the present disclosure, a multi-layered porous film is provided. The multi-layered porous film includes a first porous layer having a first plurality of pores, each with an aspect ratio of 1:2 to 1:5; a second porous layer having a second plurality of pores, each with an aspect ratio of 1:2 to 1:5; and a thermal-resistance layer having a third plurality of pores, wherein the thermal-resistance layer is disposed between the first porous layer and the second porous layer, and the thermal-resistance layer includes 50 wt % to 80 wt % of inorganic particles.

According to another embodiment of the present disclosure, a method for preparing a multi-layered porous film is provided. The method includes the steps of melting a first polyolefin resin and a blend, respectively, wherein the blend includes a second polyolefin resin and a plurality of inorganic particles; performing co-extrusion to form a multi-layered precursor film; and uniaxially elongating the multi-layered precursor film to form the multi-layered porous film.

### BRIEF DESCRIPTION OF DRAWINGS

FIG. 1 is a schematic diagram of the multi-layered porous film of the present disclosure;

FIG. 2 is an SEM diagram of the multi-layered porous film of the present disclosure;

FIG. 3 is an SEM diagram of the thermal-resistance layer of the present disclosure;

FIG. 4 is an SEM diagram of the first and second porous layers of the present disclosure; and

FIG. 5 is a flow chart depicting the preparation of a multi-porous film of the present disclosure.

### DETAILED DESCRIPTION

The following specific embodiments illustrate the detailed description of the present disclosure, such that one skilled in the art can readily conceive the other advantages and effects of the present disclosure. It should be understood that all of the structures, ratios and sizes depicted in the figures appended to this specification simply work in concert with the disclosure of the specification to enhance the understanding and perusal of one skilled in the art, but not for restricting the implementable limitations of the present disclosure. Thus, the figures do not have technically substantive meanings. Any modification of the structures, amendment of the ratios, or adjustment of sizes, without affecting the effect and achievable goal of the present disclosure, should all fall within the scope of the disclosure of the present disclosure accorded to the claims.

Please refer to FIG. 1, an embodiment of the present disclosure illustrates a first porous layer 1 comprising a first porous layer 11, a second porous layer 12 and a thermal-resistance layer 20, wherein the thermal-resistance layer 20 is disposed between the first porous layer 11 and the second porous layer 12. The first porous layer 11 and the second porous layer 12 have polyolefin resins having a plurality of pores, each with aspect ratio of 1:2 to 1:5. In one embodiment, the pores with aspect ratios of 1:2 to 1:5 account for 80% of all of the pores. When abnormal overheating occurs inside the battery, thermal shutdown caused by heat of fusion occurs as the first porous layer 11 and the second porous layer 12 which reach the melting point. As a result, ion conduction is blocked, and continuous heat release from the reaction is terminated. The thermal-resistance layer 20 has a plurality of pores formed between polyolefin resins and a plurality of inorganic particles. The melting temperature of the thermal-resistance layer 20 is increased by adding inorganic particles, and the thermal tolerance of the multi-layered porous film 1 can be 180° C. or above. Thus, the temperature working interval from thermal shutdown to film fracture can attain the range of from 40° C. to 50° C., which substantially decreases the probability of thermal runaway of the battery. The structure of the surface layers of the present disclosure includes the first porous layer 11 and the second porous layer 12 for preventing the inorganic particles from shedding from the thermal-resistance layer 20, and the multi-layered porous film 1 is not limited to be a tri-layered structure.

The polyolefin resins of the first porous layer 11, the second porous layer 12 and the thermal-resistance layer 20 includes polyethylene, polypropylene or a combination thereof, wherein polyethylene has a weight average molecular weight of from 10000 to 13000, a density of higher than 0.95 g/cm³, and a melting point of 135° C. or higher; polypropylene has a weight average molecular weight of 55000 to 70000, a density of higher than 0.9 g/cm³, a melting point of 165° C. or higher, and a meso-pentad of greater than 90%. In one embodiment, polyethylene is high density polyethylene (HDPE), and polypropylene is isotactic polypropylene (iPP). In another embodiment, the polyolefin resins of the first porous layer 11 and the second porous layer 12 include HDPE; the polyolefin resin of the thermal-resistance comprises iPP and the combination of the multi-layered porous film 1 provides wider temperature working interval to improve the safety of the batteries. To alleviate the layer shedding, the polyolefin of the thermal-resistance layer 20 can further include iPP. The combination of layers in multi-layered porous film 1 has higher temperature working interval, such that the safety of the battery is effectively improved. The polyolefin resin of the thermal-resistance layer 20 can further includes HDPE, to avoid delamination. Because a portion of the thermal-resistance layer 20 has the same material as the first porous layer 11 and the second porous layer 12, the adhesion among the polyolefin resins in each of the layers is improved. In one embodiment, the thermal-resistance layer includes 3 to 10 wt % of HDPE, 50 to 80 wt % of inorganic particles, and 10 to 47 wt % of iPP. If polyethylene is added excessively, the melting temperature of the thermal-resistance layer 20 is decreased.

The inorganic particles account for 50 to 80 wt % of the entire thermal-resistance layer 20, wherein the inorganic particles are selected from silica (SiO₂), aluminum oxide (Al₂O₃), calcium carbonate (CaCO₃), titanium dioxide (TiO₂), magnesium oxide (MgO), zinc oxide (ZnO), clay or a combination thereof. The sizes of the inorganic particles range from 0.05 μm to 2 μm. Furthermore, if the weight proportion of the inorganic particles is greater than 80%, pores in a dry process may become too big to achieve the effect of an insulating film; or if the weight proportion of the inorganic particles is lower than 50%, the melting temperature of the thermal-resistance layer 20 is not effectively increased, and pores are not effectively formed during dry elongation. In order to reach a higher melting temperature, the thermal-resistance layer 20 needs to be mixed with a high proportion of the inorganic particles. However, the higher the proportion of the inorganic particles being added to the thermal-resistance layer, the easier they shed off. The present involves the disposal of the thermal-resistance layer 20 between the first porous layer 11 and the second porous layer 12, such that the first and second porous layers in the structure of the surface layers can prevent the inorganic particles from shedding from the thermal-resistance layer 20, and thereby increasing the temperature working interval of the battery.

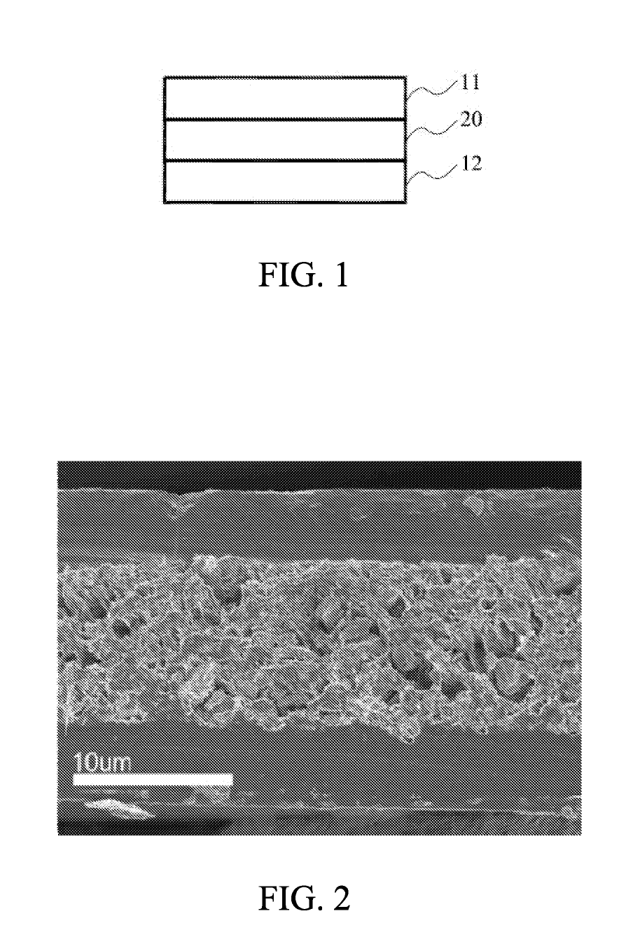

FIG. 2 illustrates the SEM diagram which corresponds to the multi-layered porous film 1 in FIG. 1. The thermal-resistance layer 20 is disposed between the first porous layer 11 and the second porous layer 12 to prevent the inorganic particles from shedding off. In an embodiment, the thickness of the first porous layer is from 5 μm to 15 μm, the thickness of the second porous layer is from 5 μm to 15 μm, the thickness of the thermal-resistance layer is from 5 μm to 15 μm and the overall thickness of the multi-layered porous film is from 15 μm to 45 μm.

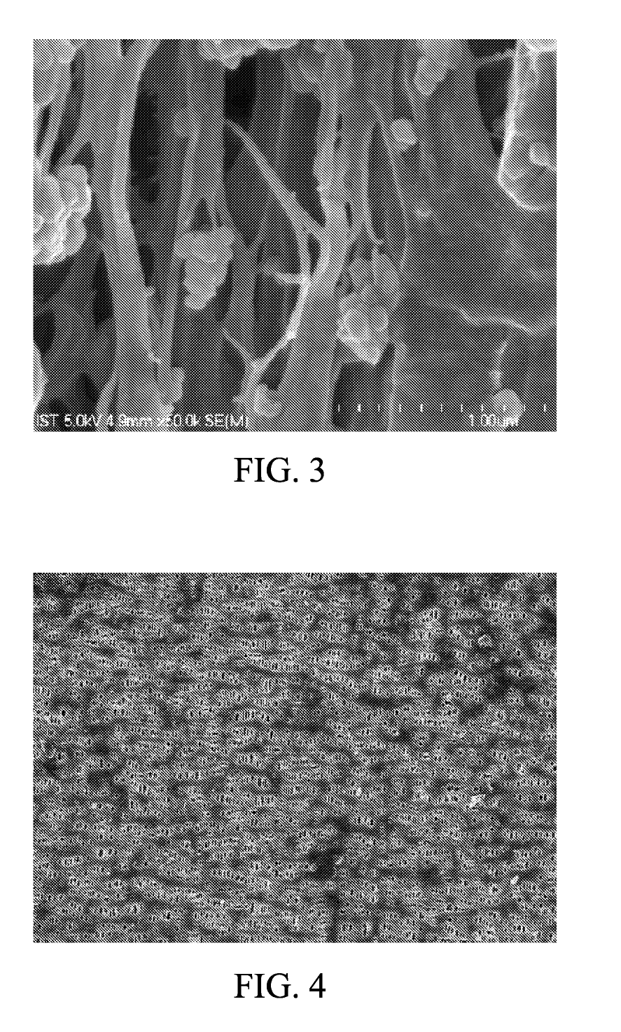

FIG. 3 illustrates the SEM diagram of the thermal-resistance layer 20. The thermal-resistance layer 20 has a plurality of pores formed by the interfacial tear between the inorganic particles and the polyolefin resin. The average pore size of the pores is from 1 μm to 2 μm. FIG. 4 illustrates the SEM diagram of the first porous layer 11 and the second porous layer 12. A plurality of pores of the first porous layer 11 and the second porous layer 12 are formed by the interfacial tear between the crystals of the polyolefin resins. The pores have an even distribution of pore diameters, a greater pore curvature, an average pore diameter of from 30 nm to 50 nm, and an aspect ratio of from 1:2 to 1:5, wherein the pores account for 80% of all of the pores.

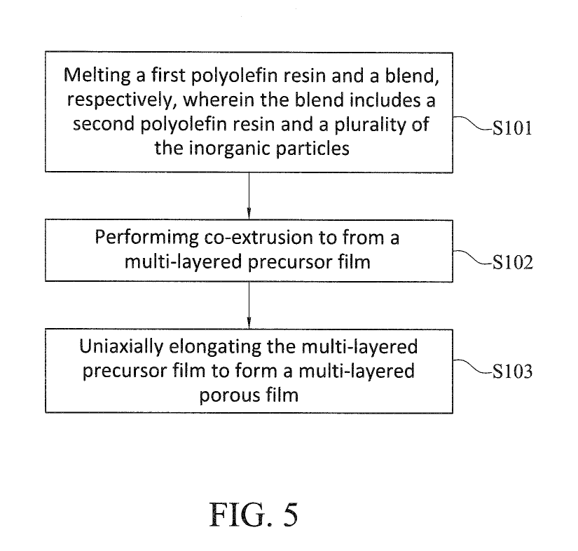

As illustrated in FIG. 5, the present disclosure also provides a method for preparing the multi-layered porous film 1, which includes the steps of: S101: melting the first polyolefin resin and a blend, respectively, wherein the blend includes the second polyolefin resin and a plurality of inorganic particles; S102: co-extruding to form a multi-layered precursor film; and S103: uniaxially elongating the multi-layered precursor film to form the multi-layered porous film. In step S101, the first polyolefin resin and the blend are fed to the different feeding ends of a co-extruder for melting. In step S102, different combinations of feeding materials are selected, and the multi-layered precursor film is co-extruded, wherein the co-extruding temperature is from 200° C. to 250° C. In an embodiment, the co-extruder has three feeding ends, wherein two of the feeding ends are disposed with the first polyolefin resins, and the other feeding end is disposed with the blend. A tri-layered precursor film is co-extruded in the order of the first polyolefin resins, the blend, and the first polyolefin resins. In step S103, the multi-layered porous film is uniaxially elongated after the multi-layered precursor film is cooled at room temperature and crystallized, wherein the multiplying factor of the uniaxial elongation is from 1.8 to 2.5, and the elongating temperature is from 100° C. to 125° C. When the multiplying factor of the uniaxial elongation is lower than 1.8, the pore diameter may become so small that the gas impedance (Gurley) is too high. Hence, it is not appropriate to apply the multi-layered porous film in an insulating film of a lithium battery. When the multiplying factor of uniaxial elongation is higher than 2.5, the pore size may become so big that the insulating film of the battery is fractured, and becomes ineffective. The present disclosure uses a dry uniaxial elongating process to form pores, wherein the pores are formed by the interfacial tear between the crystals of the polyolefin resins or between the inorganic particles and the polyolefin resins. As compared with wet phase transition, the dry uniaxial elongation simplifies the steps by not needing the use of diluents and solvents for extraction to form the pores. In addition to making pores without using solvents in the preparation method of present disclosure, the method is free of the bonding step, and thereby being cost-effective and eco-friendly.

In addition to steps S101 to S103, before step S101, there is step S100: melting and granulating the second polyolefin resin and the inorganic particles to form the blend, so as to ensure that second polyolefin resin and the inorganic particles can be thoroughly and homogeneously mixed before co-extrusion melting; after step S103, there is step S104: heating the multi-layered porous film to anneal, wherein the heating temperature is from 120° C. to 125° C., and heating time is from 3 minutes to 5 minutes. By means of annealing step, the residual stress of multi-layered porous film can be eliminated, to avoid subsequent delamination caused by the shrinkage of the multi-layered porous film.

The following exemplary embodiments illustrate the disclosure in more detail, so as to be easily realized by a person having ordinary knowledge in the art. The inventive concept may be embodied in various forms without being limited to the exemplary embodiments set forth herein.

### EMBODIMENTS

A second polyolefin resin and the inorganic particles were firstly blended in a double-screw blender for granulation, wherein the temperature was set to 210° C., and the rotating speed of the screw was at 200 rpm, to obtain plastic pellets with specific ratios of inorganic particles/second polyolefin resin. Three-layered precursor films were made by tri-layered co-extrusion. The middle screw employed the plastic pellets made as described previously. The upper and lower surfaces in each of the three-layered precursor films were made by using a first polyolefin resin as the raw material. By melting extrusion with the screw, the materials in each of the layers were extruded into the three-layered co-extrusion die, and molded to obtain a first polyolefin resin/second polyolefin resin+inorganic particles/first polyolefin resin precursor film. The precursor films in this stage not yet formed any pore. Then, the precursor films were subjected to an annealing step i.e., heated at 120° C. for 10 minutes. Uniaxial elongation at a rate of 200% at 120° C. was carried out to form thin films and pores. Finally, the precursor films were heated at 125° C. for 20 minutes for shaping, and the preparation of a multi-layered porous film is completed.

### Testing Methods

Permeability (Gurley): it is define as the time consumed as a unit volume of gas passing through a unit area (in²) of insulation film under a fixed pressure, i.e., the resistance of the insulation film against the permeation of gas. The common unit for resistance is s/10 c.c., and the resistance was assessed by a Gurley meter under a standard test ASTM D-726-58, Method B.

Meltdown temperature (Melt integrity): A testing temperature was set, and the porous films were each placed in an oven for 30 minutes. The films were observed for melting and pores collapsing.

Shutdown temperature: The testing temperature was set, and the porous films were each placed in the oven for 5 minutes. The films were taken out from the oven, and were each measure for its gas resistance (Gurley). If the Gurley value significantly increased, this temperature was the shutdown temperature.

Mechanical strength (Tensile): An elongation test was performed along the direction of MD by a universal tensile machine, the elongating rate was 50 mm/min, and the strength at the broken point is the mechanical strength. The testing standard was ASTM D882 Standard Test Method for Tensile Properties of Thin Plastic Sheeting.

Stripping resistance test: The films were each peeled off by the universal tensile machine with a rate of 50 mm/min, and the value generated was the average value in testing process.

### Embodiment 1

A three-layered precursor film, prepared by co-extrusion in the steps above, had the structure of polypropylene/polypropylene+CaCO₃/polypropylene and a total thickness of 45 μm. The upper and lower surface layers of the film were made of the polypropylene material, which had a melting point of 163° C. and a thickness of 15 μm. The intermediate layer included 22 wt % of polypropylene and 78 wt % of CaCO₃, wherein the CaCO₃ particles had an average size of 2 μm and the intermediate layer had a thickness of 15 μm. Micropores were generated by an elongating process for pore formation. The thickness of the film was 30 μm after the process was completed. The testing properties were summarized in Table 1.

### Embodiment 2

A three-layered precursor film, prepared by co-extrusion in the steps above, had the structure of polyethylene/polypropylene+CaCO₃/polyethylene and a total thickness of 45 μm. The upper and lower surface layers of the film were made of the polyethylene material, which had a melting point of 135° C. and a thickness of 15 μm. The intermediate layer included 45 wt % of polypropylene and 55 wt % of CaCO₃, wherein the CaCO₃ particles had an average size of 2 μm and the intermediate layer had a thickness of 15 μm. Micropores were generated by an elongating process for pore formation, and the thickness of the film was 30 μm after the process was completed. The testing properties were summarized in Table 1.

### Embodiment 3

A three-layered precursor film, prepared by co-extrusion in the steps above, had the structure of polyethylene/polypropylene+CaCO₃/polyethylene and a total thickness of 45 μm. The upper and lower surface layers of the film were made of the polyethylene material, which had a melting point of 135° C. and a thickness of 15 μm. The intermediate layer included 22 wt % of polypropylene and 78 wt % of CaCO₃ wherein the CaCO₃ particles have average size of 2 μm and the intermediate layer had thickness of 15 μm. Micropores were generated by an elongating process for pore formation, and the thickness of the film was 30 μm after the process was completed. The testing properties were summarized in Table 1.

### Embodiment 4

A three-layered precursor film, prepared by co-extrusion in the steps above, had the structure of polyethylene/polypropylene+CaCO₃+polyethylene/polyethylene and a total thickness of 45 μm. The upper and lower surface layers of the film were made of the polyethylene material, which had a melting point of 135° C. and a thickness of 15 μm. The intermediate layer included 17 wt % of polypropylene, 5 wt % of polyethylene, and 78 wt % of CaCO₃, wherein the CaCO₃ particles had an average size of 2 μm, and the intermediate layer had a thickness of 15 μm. Micropores were generated by elongation for pore formation, and the thickness of the film was 30 μm after the process was completed. The testing properties were summarized in Table 1.

### Comparative Example 1

A commercially available polypropylene/polyethylene/polypropylene (PP/PE/PP) three-layered insulation film (Celgard 2325) was assessed, and the total thickness of the film was 25 μm. The testing properties were summarized in Table 1.

### Comparative Example 2

A three-layered precursor film, prepared by co-extrusion in the steps above, had the structure of polyethylene/polypropylene+CaCO₃/polyethylene and a total thickness of 45 μm. The upper and lower surface layers of the film were made of the polyethylene material, which had a melting point of 135° C. and a thickness of 15 μm. The intermediate layer included 70 wt % of polypropylene and 30 wt % of CaCO₃, wherein the CaCO₃ particles had an average size of 2 μm and the intermediate layer had a thickness of 15 μm. Micropores were generated by an elongating process for pore formation, and the thickness of the film was 30 μm after the process was completed. The testing properties were summarized in Table 1.

### Comparative Example 3

A monolayered precursor film was prepared by extrusion, and the film included 45 wt % of polyethylene and 55 wt % of CaCO₃, wherein CaCO₃ had an average particle size of 0.8 μm and the monolayered precursor film had a thickness of 45 μm. Micropores were generated by an elongating process for pore formation, and the thickness of the film was 30 μm after the process was completed. The testing properties were summarized in Table 1.

### Comparative Example 4

A monolayered precursor film was fabricated by extrusion, and the film included 45 wt % of polypropylene and 55 wt % of CaCO₃, wherein CaCO₃ had an average particle size of 2 μm and the monolayered precursor film had a thickness of 45 Micropores were generated by an elongating process for pore formation, and the thickness of the film was 30 μm after the process was completed. The testing properties were summarized in Table 1.

TABLE 1

| | Embodi- | Embodi- | Embodi- | Embodi- | Comparative | Comparative | Comparative | Comparative |
|---|---|---|---|---|---|---|---|---|
| | ment 1 | ment 2 | ment 3 | ment 4 | example 1 | example 2 | example 3 | example 4 |
| Thickness | 30 | 30 | 30 | 30 | 25 | 30 | 30 | 30 |
| (μm) | | | | | | | | |
| Permeability | 55 | 33 | 37 | 44 | 25 | 110 | 10 | 15 |
| (Gurley) | | | | | | | | |
| Meltdown | 185 | 185 | 190 | 185 | 160 | 175 | 160 | 190 |
| temperature | | | | | | | | |
| (° C.) | | | | | | | | |
| Shutdown | 155 | 135 | 135 | 135 | 135 | 135 | — | — |
| temperature | | | | | | | | |
| (° C.) | | | | | | | | |
| Mechanical | 1412 | 1395 | 1229 | 1316 | 1622 | 1412 | 207 | 288 |
| Strength | | | | | | | | |
| (kg/cm²) | | | | | | | | |
| Peeling | 612 | 485 | 453 | 582 | 402 | 437 | — | — |
| resistance | | | | | | | | |
| (g_{f}/25 mm) | | | | | | | | |

As shown in Table 1, as compared with the comparative examples, the embodiments of present disclosure provided higher temperature working intervals (i.e., 30° C. to 55° C.). In comparative example 2, though the temperature working interval reached 40° C., the permeability was higher than 110 s/10 c.c. This indicates that as inorganic particles were 30 wt %, the pores were ineffectively formed by dry elongation. In comparative examples 3 and 4 of monolayered precursor film, though the general meltdown temperature could be increased with the inorganic particles added, bigger pores were generated after the dry elongating process. As such, the thermal shutdown cannot be generated. In embodiments 3 and 4, the adhesion of the thermal-resistance layer was efficiently increased by adding a small amount of polyethylene, and thereby avoiding delamination.

The above examples are provided only to illustrate the principle and effect of the present disclosure, and they do not limit the scope of the present disclosure. One skilled in the art should understand that, modifications and alterations can be made to the above examples, without departing from the spirit and scope of the present disclosure. Therefore, the scopes of the present disclosure should be accorded to the disclosure of the appended claims.

1. A multi-layered porous film, comprising:
a first porous layer having a first plurality of pores each with an aspect ratio of 1:2 to 1:5;
a second porous layer having a second plurality of pores each with an aspect ratio of 1:2 to 1:5; and
a thermal-resistance layer having a third plurality of pores, wherein the thermal-resistance layer is disposed between the first porous layer and the second porous layer, and the thermal-resistance layer comprises 50 wt % to 80 wt % of inorganic particles.

2. The multi-layered porous film of claim 1, wherein each of the first porous layer, the second porous layer, and the thermal-resistance layer comprises a polyolefin resin.

3. The multi-layered porous film of claim 2, wherein the polyolefin resin comprises one selected from the group consisting of polyethylene, polypropylene and a combination thereof.

4. The multi-layered porous film of claim 3, wherein the polyethylene has a weight average molecular weight of from 10000 to 13000.

5. The multi-layered porous film of claim 3, wherein the polypropylene has a weight average molecular weight of from 55000 to 70000.

6. The multi-layered porous film of claim 2, wherein the polyolefin resin of the first porous layer and the polyolefin resin of the second porous layer each comprise polyethylene.

7. The multi-layered porous film of claim 2, wherein the polyolefin resin of the thermal-resistance layer comprises polypropylene.

8. The multi-layered porous film of claim 7, wherein the polyolefin resin of the thermal-resistance layer further comprises polyethylene.

9. The multi-layered porous film of claim 8, wherein the thermal-resistance layer comprises 3 wt % to 10 wt % of the polyethylene, 50 wt % to 80 wt % of the inorganic particles, and 10 wt % to 47 wt % of the polypropylene.

10. The multi-layered porous film of claim 1, wherein an average pore diameter of the first plurality of pores of the first porous layer is in a range of from 30 nm to 50 nm, an average pore diameter of the second plurality of pores of the second porous layer is in a range of from 30 nm to 50 nm, and an average pore diameter of the third plurality of pores of the thermal-resistance layer is in a range of from 1 μm to 2 μm.

11. The multi-layered porous film of claim 1, wherein a thickness of at least one of the first porous layer, the second porous layer and the thermal-resistance layer is in a range of from 5 μm to 15 μm.

12. The multi-layered porous film of claim 2, wherein the first plurality of pores of the first porous layer are formed by an interfacial tear between crystals of the polyolefin resin of the first porous layer, the second plurality of pores of the second porous layer are formed by an interfacial tear between crystals of the polyolefin resin of the second porous layer, and the third plurality of pores of the thermal-resistance layer are formed by an interfacial tear between the inorganic particles and the polyolefin resin of the thermal-resistance layer.

13. A method for preparing a multi-layered porous film, comprising:
melting a first polyolefin resin and a blend, respectively, wherein the blend comprises a second polyolefin resin and a plurality of inorganic particles;
performing co-extrusion to form a multi-layered precursor film; and
uniaxially elongating the multi-layered precursor film to form the multi-layered porous film.

14. The method of claim 13, wherein the first polyolefin resin and the second polyolefin resin each comprise one selected from the group consisting of polyethylene, polypropylene, and a combination thereof.

15. The method of claim 14, wherein the polyethylene has a weight average molecular weight of from 10000 to 13000, and the polypropylene has a weight average molecular weight of from 55000 to 70000.

16. The method of claim 13, wherein an amount of the inorganic particles is in a range of from 50 wt % to 80 wt % based on the blend.

17. The method of claim 13, further comprising, prior to melting the first polyolefin resin and the blend, melting and granulating the second polyolefin resin and the inorganic particles to form the blend.

18. The method of claim 13, wherein the multi-layered precursor film is a tri-layered precursor film fabricated by the co-extrusion in an order of the first polyolefin resin, the blend, and the first polyolefin resin.

19. The method of claim 13, wherein uniaxially elongating the multi-layered precursor film is performed at a multiplying factor of from 1.8 to 2.5, and an elongating temperature is in a range of from 100° C. to 125° C.

20. The method of claim 13, further comprising, after uniaxially elongating the multi-layered precursor film, heating the multi-layered porous film for annealing.
